(19) United States
(12) Patent Application Publication
(10) Pub. No.: US 2025/0173493 A1
(43) Pub. Date: May 29, 2025

(54) METHODS AND ARRANGEMENTS FOR OPTIMALLY DESIGNING COMPLEX RESONATOR NETWORK

(71) Applicant: IQM FINLAND OY, Espoo (FI)

(72) Inventors: Johannes HEINSOO, Espoo (FI); Caspar OCKELOEN-KORPPI, Espoo (FI); Alessandro LANDRA, Espoo (FI); Jukka RÄBINÄ, Espoo (FI)

(21) Appl. No.: 18/840,237

(22) PCT Filed: Mar. 14, 2022
(86) PCT No.: PCT/FI2022/050161

§ 371 Date: Aug. 21, 2024

(51) Int. Cl. G06F 30/373; G06F 30/18; G06F 111/10

(52) U.S. Cl. CPC G06F 30/373; G06F 30/18; G06F 2111/10

(57) ABSTRACT

For producing a quantum microwave circuit, a network model is provided. Each resonator element therein is characterised by one or more respective physical quantities that define a contribution of the respective resonator element to one or more resonator modes of the microwave circuit. Values of respective parameters (x) constitute a vector (1), an initial form of which is (2). A characteristic of said microwave circuit at the t: th resonator mode as a quantity dependent on a complex number st having a real part and an imaginary part. The real part is defined in relation to a target decay constant and the imaginary part is defined in relation to a target resonance frequency of the respective resonator mode. Beginning from said initial form (2), a numerical optimization method finds the vector (1) that gives an extreme value of an objective function dependent on said quantity. A physical instance of said microwave circuit is manufactured with the respective physical quantities having said found values of the parameters (x).

### FIELD OF THE INVENTION

The present disclosure relates to quantum computing. More particularly, the present disclosure relates to methods and arrangements for optimally designing a complex resonator network for use in a quantum computing system. Additionally, the present disclosure relates to a quantum computing system.

### BACKGROUND OF THE INVENTION

A quantum computing system comprises one or more quantum processing units (QPUs) that are placed into a cryostat for operating them at temperatures very close to absolute zero. A QPU typically comprises plurality of qubits as well as auxiliary circuits, for example a plurality of microwave resonator elements, built on one or more pieces of substrate material such as sapphire, fused silica, or crystalline quartz. In many cases, the microwave resonator elements form complex resonator networks that must be carefully designed to exhibit the required frequency characteristics. Parameters that come into question include target frequencies and lifetimes, of which the latter may be said to represent line widths in the frequency spectrum.

FIG. 1 illustrates a network model of a simple microwave circuit. A transmission line 101 runs between an input port 102 and an output port 103. Coupled to the transmission line 101 are three resonator elements 104, 105, and 106. Each of the resonator elements 104, 105, and 106 is characterised by one or more respective physical quantities that define a contribution of the respective resonator element to one or more resonator modes of the microwave circuit. Examples of such physical quantities include, but are not limited to, the physical dimensions of parts of the resonator element, the length of the transmission line portions from the coupling point of the resonator element to the input and output ports 101 and 102, and distances between parts of adjacent resonator elements from each other.

The values of said physical quantities may be considered as degrees of freedom or free parameters in the overall problem of making the microwave circuit fulfil its intended task as effectively as possible. As the effects of the various free parameter values are interlinked in complicated ways, it is not straightforward to find the combination of parameter values that would give the optimum result.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

It is an objective to provide a method and an arrangement for optimally designing a complex resonator network for efficient use in a quantum computing system. The method and arrangement should allow finding the optimal combination of free parameter values in a design accurately and with reasonable computational effort.

These and further advantageous objectives are achieved by solving a multidimensional optimisation problem, in which the impedance of the microwave circuit is evaluated in Laplace domain, using complex-valued frequency in which the real part is the target decay constant of the appropriate resonator mode and the imaginary part is the corresponding target resonance frequency. The objective function, an extreme value of which is to be found through numerical optimisation, depends on both the complex-valued frequency and the free parameter values.

According to a first aspect, there is provided a method for producing a microwave circuit for use in a quantum computing system. The method comprises providing a network model of said microwave circuit. Said network model comprises at least a plurality of resonator elements, wherein each of said resonator elements is characterised by one or more respective physical quantities that define a contribution of the respective resonator element to one or more resonator modes of the microwave circuit. The method comprises representing values of said physical quantities with respective parameters (x) that together constitute a vector (\vec{x}), and selecting initial values for said parameters (x) to form an initial form (\vec{x}₀) of said vector (\vec{x}). The method further comprises describing a characteristic of said microwave circuit at the i:th resonator mode as a quantity dependent on a complex number sᵢ having a real part and an imaginary part. The real part of sᵢ is defined in relation to a target decay constant of the respective resonator mode and the imaginary part of sᵢ is defined in relation to a target resonance frequency of the respective resonator mode. Beginning from said initial form (\vec{x}₀), the method comprises using a numerical optimization method to find the values of the parameters (x) constituting the vector (\vec{x}) that give an extreme value of an objective function dependent on said quantity. The method comprises manufacturing a physical instance of said microwave circuit, in which the respective physical quantities have said found values of the parameters (x).

According to an embodiment, said quantity is an impedance Z(sᵢ,\vec{x}) of said microwave circuit at the i:th resonator mode. In such a case, the real part of sᵢ is said target decay constant of the respective resonator mode and the imaginary part of sᵢ is said target resonance frequency of the respective resonator mode.

According to an embodiment, said impedance Z(sᵢ,\vec{x}) of said microwave circuit at the i:th resonator mode is a sum ΣⱼZ(s_{i,j},\vec{x}) over j points around the target i:th resonator mode, the real part of each s_{i,j} being the decay constant of the respective resonator mode at the respective j:th point and the imaginary part of each sᵢ being the resonance frequency of the respective resonator mode at the respective j:th point.

According to an embodiment, said using of a numerical optimization method involves finding the values of the parameters (x) constituting the vector (\vec{x}) that minimize

$${max}_{i} \frac{1}{Z ( {s}_{i} , \vec{x} )}$$

where the index i goes over a plurality of resonator modes.

According to an embodiment, said microwave circuit comprises k ports, where k is a positive integer. Impedances between n:th and m:th ports of said microwave circuit may then be described as matrix elements Zₙₘ of a k×k square matrix so that n∈[1,k] and m∈[1,k]. Said method may be performed on the diagonal elements (Zₙₙ) of said matrix.

According to an embodiment, said quantity is an admittance Y(sᵢ,\vec{x}) of said microwave circuit at the i:th resonator mode. The real part of sᵢ may then be said target decay constant of the respective resonator mode and the imaginary part of sᵢ may be said target resonance frequency of the respective resonator mode.

According to an embodiment, said microwave circuit comprises k ports, where k is a positive integer. Admittances between n:th and m:th ports of said microwave circuit may be described as matrix elements Y_{n,m} of a k×k square matrix so that n∈[1,k] and m∈[1,k]. Said method may then be performed on the diagonal elements (Y_{n,n}) of said matrix.

According to an embodiment, said using of a numerical optimization method may involve finding the values of the parameters (x) constituting the vector (\vec{x}) that minimize

$$max \vert {Y}_{{n , n}_{i}} ( {s}_{i} , \vec{x} ) \vert . \qquad 1$$

where the index i goes over a plurality of resonator modes.

According to an embodiment, said microwave circuit comprises k ports, where k is a positive integer. Said quantity may be a scattering property S of said microwave circuit, being represented by a matrix of scattering parameters

$${S}_{{n , m}_{i}}$$

between n:th and m:th ports at the i:th resonator mode, with 1≤n≤k and 1≤m≤k. The real part of sᵢ is then said target decay constant of the respective resonator mode, and the imaginary part of sᵢ is said target resonance frequency of the respective resonator mode. In such a case, said using of a numerical optimization method may involve finding the values of the parameters (x) constituting the vector (\vec{x}) that minimize

$$max \vert {S}_{{n , m}_{i}} ( {s}_{i} , \vec{x} ) \vert . \qquad 2$$

where the index i goes over a plurality of resonator modes.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 illustrates a network model of a simple microwave circuit, and

FIG. 2 illustrates a method.

### DETAILED DESCRIPTION

In the following description, reference is made to the accompanying drawings, which form part of the disclosure, and in which are shown, by way of illustration, specific aspects in which the present disclosure may be placed. It is understood that other aspects may be utilised, and structural or logical changes may be made without departing from the scope of the present disclosure. The following detailed description, therefore, is not to be taken in a limiting sense, as the scope of the present disclosure is defined be the appended claims.

For instance, it is understood that a disclosure in connection with a described method may also hold true for a corresponding device or system configured to perform the method and vice versa. For example, if a specific method step is described, a corresponding device may include a unit to perform the described method step, even if such unit is not explicitly described or illustrated in the figures. On the other hand, for example, if a specific apparatus is described based on functional units, a corresponding method may include a step performing the described functionality, even if such step is not explicitly described or illustrated in the figures. Further, it is understood that the features of the various example aspects described herein may be combined with each other, unless specifically noted otherwise.

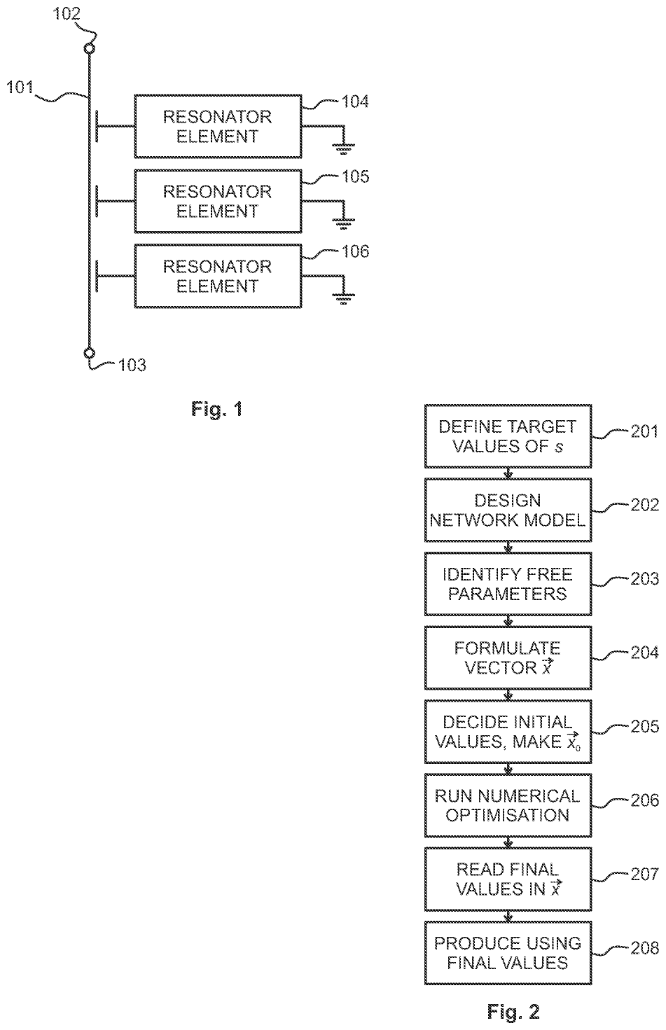

Microwave circuits, like for example the one for which a network model is shown in FIG. 1, generally have k ports, where k is a positive integer. In the case of FIG. 1, k=2. Of interest may be any impedance of the microwave circuit, i.e. the impedance at any of said ports or between any pair of ports. In general, the impedances between n:th and m:th ports of a microwave circuit are described as matrix elements Zₙₘ of a k×k square matrix so that n∈[1,k] and m∈[1,k]. Considering admittance Y or scattering property S instead of impedance Z, the matrix elements Y_{n,m} of an admittance matrix or the matrix elements S_{n,m} of a scattering matrix may be used to describe a general k-port microwave network.

Frequency as such is a real-valued quantity. Therefore, the frequency characteristics of microwave circuits are often described using graphs that indicate a parameter value, like the value of the S21 scattering parameter or other S-parameter, or the value of an impedance Z, as a function of frequency. Such frequency characteristics of a microwave circuit depend on the values selected for a number of physical quantities in the circuit elements, as described above. It is possible to represent values of said physical quantities with respective parameters x and collect them together to constitute a vector \vec{x}. It is possible to then fit an analytical expression on numerically evaluated S-parameter S(f,\vec{x}) or impedance Z(f,\vec{x}) over real valued frequency f to extract the resonant frequencies and lifetimes and then minimize the deviation of frequencies and lifetimes from target values. Said minimizing may be done with numerical optimization methods.

It has been found, however, that such an approach may lead to using objective functions in the numerical optimization that are quite irregular and thus not well suited for standard numerical optimization methods.

Therefore, it is suggested to evaluate the impedance of the microwave circuit in the Laplace domain, using a complex valued frequency s. The real part of s is related to the decay constants of the resonator modes of the microwave circuit, and the imaginary part of s is related to the real-valued resonance frequency.

FIG. 2 illustrates schematically a method for producing a microwave circuit for use in a quantum computing system. Step 201 in the method involves selecting target values for the complex-valued frequency s. Taken that the microwave circuit to be designed may have a plurality of resonator modes of interest, it is advantageous to define a respective plurality of target values sᵢ, where the index i goes from 1 to the total number of resonator modes of interest.

Step 202 in the method involves providing a network model of the microwave circuit. Very often an experienced designer of microwave circuits can predict quite accurately the approximate effect of various circuit elements on the frequency characteristics, so it is not unreasonable to assume that, at least qualitatively, the network model provided at step 202 can already be said to represent a relatively feasible practical implementation. The network model provided at step 202 comprises at least a plurality of resonator elements. In addition, it may comprise other circuit elements like transmission lines, and/or even optical or (micro) mechanical elements and/or any combinations of any of said recited elements.

Each of said resonator elements is characterised by one or more respective physical quantities that define a contribution of the respective resonator element to one or more resonator modes of the microwave circuit. In addition to pure resonator elements, it may be possible to model the effect of other kinds of circuit elements to the resonator modes through their respective physical quantities. Step 203 in the method involves identifying the pertinent physical quantities of at least the resonator elements and representing values of said physical quantities with respective parameters. These parameters were designated as parameters x above, and together they constitute a vector \vec{x}. There are as many elements in the vector \vec{x} as there are identified “free” parameters at step 203. Formulating the vector \vec{x} is shown as a method step 204 of its own in FIG. 2.

Step 205 in the method comprises selecting initial values for said parameters x to form an initial form \vec{x}₀ of the vector \vec{x}. The initial values may be selected by random, or at least some of them may be selected following approximate understanding of how the resonator elements may affect the frequency characteristics of the microwave circuit. For example, it is known that a resonator of certain predefined length, in relation to a quarter wavelength on a known frequency, tends to either pass or attenuate microwave signals on that frequency and its multiples depending on how the resonator is coupled in the circuit. The eventual optimal length of the resonator may be somewhat different, due to e.g. complicated interactions between various parts and circuit elements in the microwave circuit, but such a predefined length may well serve as an initial value for the free parameter representing the resonator length at step 205.

Step 206 in the method involves running the numerical optimisation part. An impedance Z of said microwave circuit at the i:th resonator mode is described as Z(sᵢ,\vec{x}). Like in the explanation above, sᵢ is a complex number having a real part and an imaginary part, the real part of sᵢ being defined in relation to a target decay constant of the respective resonator mode and the imaginary part of sᵢ being defined in relation to a target resonance frequency of the respective resonator mode. Beginning from said initial form \vec{x}₀, the use of a numerical optimization method aims at finding the values of the parameters x (constituting the vector \vec{x}) that give an extreme value of an objective function dependent on Z(sᵢ,\vec{x}).

The use of an objective function is typical to numerical optimisation methods. The objective function expresses a quantity that will, due to the selected form of the objective function, assume an extreme value when the best possible combination of free parameter values has been found. In one embodiment, the use of a numerical optimization method in step 206 involves finding the values of the parameters x (constituting the vector \vec{x}) that minimize

$${max}_{i} \frac{1}{Z ( {s}_{i} , \vec{x} )}$$

where the index i goes over the plurality of resonator modes of interest.

Step 207 in the method is the output step of the numerical optimisation process and involves reading the final parameter values x (constituting the vector \vec{x}) that according to the numerical optimisation provide the best match with the target values sᵢ. As the eventual goal is to utilise the results in manufacturing an actual physical microwave circuit, FIG. 2 shown manufacturing a physical instance of said microwave circuit as step 208. The respective physical quantities in the manufactured microwave circuit have said found values of the parameters x.

In case the numerical optimisation at step 206 failed to give final parameter values x that made the optimisation converge sufficiently on the target, it is possible to go back to step 202, redesign the network model, and then repeat steps 203, 204, 205, and 206. This loop can be circulated until sufficient convergence is achieved.

As an alternative to straightforwardly using the target decay constant of the respective resonator mode as the real part of sᵢ and the target resonance frequency of the respective resonator mode as the imaginary part of sᵢ, one may treat the description Z(sᵢ,\vec{x}) of the impedance Z of the microwave circuit at the i:th resonator mode as a sum ΣⱼZ(s_{i,j},\vec{x}) over j points around the target i:th resonator mode. In said sum, the real part of each s_{i,j} is the decay constant of the respective resonator mode at the respective j:th point and the imaginary part of each sᵢ is the resonance frequency of the respective resonator mode at the respective j:th point. Such a “group of points s” approach may produce a numerically more stable form for the optimisation calculations.

Returning to the impedance matrix approach mentioned earlier, the microwave circuit to be designed may comprise k ports, where k is a positive integer. As explained earlier, the impedances between n:th and m:th ports of such a microwave circuit may be described as matrix elements Zₙₘ of a k×k square matrix so that n∈[1,k] and m∈[1,k]. Experiments have shown that it may be computationally cheaper, by approximately the order 2^{k}, to perform the method explained above on the diagonal elements (Zₙₙ) than on the other elements of said matrix.

Above it was already pointed out that instead of impedance, one may consider the admittance or scattering property of the microwave network. In such cases, the use of a numerical optimization method may involve finding the values of the parameters (x) constituting the vector (\vec{x}) that minimize

$$max \vert {Y}_{{n , n}_{i}} ( {s}_{i} , \vec{x} ) \vert$$

where the index i goes over a plurality of resonator modes, or finding the values of the parameters (x) constituting the vector (\vec{x}) that minimize

$$max \vert {S}_{{n , m}_{i}} ( {s}_{i} , \vec{x} ) \vert$$

where the index i goes over a plurality of resonator modes.

It is obvious to a person skilled in the art that with the advancement of technology, the basic idea of the invention may be implemented in various ways. The invention and its embodiments are thus not limited to the examples described above, instead they may vary within the scope of the claims.

1. A method for producing a microwave circuit for use in a quantum computing system, the method comprising:
providing a network model of said microwave circuit, said network model comprising at least a plurality of resonator elements, wherein each of said resonator elements is characterised by one or more respective physical quantities that define a contribution of the respective resonator element to one or more resonator modes of the microwave circuit,
representing values of said physical quantities with respective parameters (x) that together constitute a vector (\vec{x}),
selecting initial values for said parameters (x) to form an initial form (\vec{x}₀) of said vector (\vec{x}),
describing a characteristic of said microwave circuit at the i:th resonator mode as a quantity dependent on a complex number sᵢ having a real part and an imaginary part, the real part of sᵢ being defined in relation to a target decay constant of the respective resonator mode and the imaginary part of sᵢ being defined in relation to a target resonance frequency of the respective resonator mode,
beginning from said initial form (\vec{x}₀), using a numerical optimization method to find the values of the parameters (x) constituting the vector (\vec{x}) that give an extreme value of an objective function dependent on said quantity, and
manufacturing a physical instance of said microwave circuit, in which the respective physical quantities have said found values of the parameters (x).

2. The method according to claim 1, wherein said quantity is an impedance Z(sᵢ, \vec{x}) of said microwave circuit at the i:th resonator mode, the real part of sᵢ is said target decay constant of the respective resonator mode and the imaginary part of sᵢ is said target resonance frequency of the respective resonator mode.

3. The method according to claim 2, wherein impedance Z(sᵢ, \vec{x}) of said impedance of said microwave circuit at the i:th resonator mode is a sum ΣⱼZ(s_{i,j}, \vec{x}) over j points around the target i:th resonator mode, the real part of each s_{i,j} being the decay constant of the respective resonator mode at the respective j:th point and the imaginary part of each sᵢ being the resonance frequency of the respective resonator mode at the respective j:th point.

4. The method according to claim 1, wherein said using of a numerical optimization method involves finding the values of the parameters (x) constituting the vector (\vec{x}) that minimize
$${max}_{i} \frac{1}{Z ( {s}_{i} , \vec{x} )}$$
where the index i goes over a plurality of resonator modes.

5. The method according to claim 1, wherein:
said microwave circuit comprises k ports, where k is a positive integer,
impedances between n:th and m:th ports of said microwave circuit are described as matrix elements Zₙₘ of a k×k square matrix so that n∈[1, k] and m∈[1, k], and
said method is performed on the diagonal elements (Zₙₙ) of said matrix.

6. The method according to claim 1, wherein said quantity is an admittance Y(sᵢ, \vec{x}) of said microwave circuit at the i:th resonator mode, the real part of sᵢ is said target decay constant of the respective resonator mode and the imaginary part of sᵢ is said target resonance frequency of the respective resonator mode.

7. The method according to claim 6, wherein:
said microwave circuit comprises k ports, where k is a positive integer,
admittances between n:th and m:th ports of said microwave circuit are described as matrix elements Y_{n,m} of a k×k square matrix so that n∈[1, k] and m∈[1, k], and
said method is performed on the diagonal elements (Y_{n,n}) of said matrix.

8. The method according to claim 7, wherein said using of a numerical optimization method involves finding the values of the parameters (x) constituting the vector (\vec{x}) that minimize
$$max \vert {Y}_{{n , n}_{i}} ( {s}_{i} , \vec{x} ) \vert$$
where the index i goes over a plurality of resonator modes.

9. The method according to claim 1, wherein:
said microwave circuit comprises k ports, where k is a positive integer,
said quantity is a scattering property S of said microwave circuit, being represented by a matrix of scattering parameters
$${S}_{{n , m}_{i}}$$
between n:th and main pons at the i:th resonator mode, with 1≤n≤k and 1≤m≤k,
the real part of sᵢ is said target decay constant of the respective resonator mode,
the imaginary part of sᵢ is said target resonance frequency of the respective resonator mode, and
said using of a numerical optimization method involves finding the values of the parameters (x) constituting the vector (\vec{x}) that minimize
$$max \vert {S}_{{n , m}_{i}} ( {s}_{i} , \vec{x} ) \vert$$
where the index i goes over a plurality of resonator modes.
